(19) United States
(12) Patent Application Publication
(10) Pub. No.: US 2025/0005971 A1
(43) Pub. Date: Jan. 2, 2025

(54) DEVELOPMENT ENVIRONMENT FACILITATING REMOTE TESTING OF AUTOMOTIVE EMBEDDED DEVICE

(71) Applicant: Mitsubishi Electric Automotive America, Inc., Mason, OH (US)

(72) Inventors: Grygorii MAISTRENKO, Northville, MI (US); Michael Deen HORANI, Northville, MI (US)

(21) Appl. No.: 18/345,116

(22) Filed: Jun. 30, 2023

(51) Int. Cl. G07C 5/00; G07C 5/08

(52) U.S. Cl. CPC G07C 5/008; G07C 5/0808

(57) ABSTRACT

A system for testing an embedded device in an automotive component includes a central computing device, plurality of tools, a testing structure, and a remote computing device. The plurality of tools supplements the testing of the embedded device. The testing structure holds and connects the central computing device, the embedded device, the automotive component, and the plurality of tools. The remote computing device is physically separate from the testing structure. The remote computing device controls the central computing device (i) to cause the embedded device to function and (ii) to perform the testing of the embedded device. The remote computing device further controls the central computing device to cause the plurality of tools to provide (i) varying physical conditions under which the embedded device is tested and (ii) a plurality of mechanisms that observe and obtain testing results.

### BACKGROUND

Innovation in the automobile industry is characterized by the development of increasingly complex electrical and electromechanical automotive components that require extensive testing prior to distribution in a vehicle product line. Even after distribution, these components may require ongoing testing to resolve unforeseen issues that arise while vehicles are in use.

Modern automotive components are controlled by microcomputers and electrical circuitry that are embedded within the automotive components. Testing of the automotive components therefore includes testing of the automotive embedded devices that control respective components.

Conventional testing of an automotive embedded device in an automotive component is performed on a testing structure that is known in the art as a test bench. The automotive component and a testing system are disposed on the test bench.

The automotive component provided on the test bench may have only a single part that needs to be tested. Examples of such a single part automotive component are a windshield wiper or a headlamp. Alternatively, the automotive component provided on the test bench may have multiple parts (peripherals) that need to be tested. Examples of such a multiple part automotive components are an infotainment system or an airbag device.

Whether the automotive component having the controlling automotive embedded device to be tested is a single part component or a multiple part component, the testing system provided on the testing structure will have corresponding tools for observing and obtaining results of the testing. In a conventional testing system of an automotive embedded device in an automotive component, a user operates a computing apparatus to perform the testing, and the user physically manipulates the tools for observing and obtaining the results of the testing.

While the conventional system of testing an automotive embedded device might be considered satisfactory for a single user performing testing at a single testing location, modern automotive manufacturing is a completely global enterprise. Engineers responsible for testing embedded devices in automotive components are spread out across multiple offices, at multiple remote locations, in multiple countries. Unfortunately, there are both legal and practical constraints that make it impossible to provide to the multiple global remote test sites (i) required automotive components and embedded control devices; (ii) testing structures and testing systems; and (iii) test vehicles that can be used for testing in actual driving environments.

### SUMMARY

The present disclosure therefore reveals a development/test environment that facilitates remote testing of an automotive embedded device, in an automotive component, that is disposed on a testing structure at a central testing location. The development environment affords to a remote testing user the ability to manipulate the tools on the testing structure, which are used to observe and obtain testing results, as if the remote testing user were physically located at the central testing location.

Accordingly, one embodiment disclosed herein describes a system of testing an automotive embedded device. The automotive embedded device is hardware embedded in an automotive component. The system comprises a processor-based central computing device, a plurality of tools, a testing structure, and a processor-based remote computing device. The plurality of tools, controlled by the central computing device, supplements the testing of the automotive embedded device. The testing structure holds and connects the central computing device, the automotive embedded device, the automotive component, and the plurality of tools.

The processor-based remote computing device is disposed physically separate from the testing structure. The remote computing device and the central computing device communicate through a network.

The remote computing device controls, over the network, the central computing device (i) to cause the automotive embedded device to function and (ii) to perform the testing of the automotive embedded device. The remote computing device further controls, over the network, in performing the testing of the automotive embedded device, the central computing device to cause the plurality of tools to provide (i) a plurality of varying physical conditions under which the automotive embedded device is tested and (ii) a plurality of mechanisms that observe and obtain testing results.

A second embodiment disclosed herein describes a computing apparatus for testing an automotive embedded device, the automotive embedded device being hardware embedded in an automotive component. The computing apparatus comprises a transceiver, a processor, an electronic data storage, and a bus.

The transceiver is configured to transmit and receive data over a network. The electronic data storage stores programming. The bus is configured to transfer data among the electronic data storage, the transceiver, and the processor, rendering the processor cooperatively operable with the electronic data storage and the transceiver to execute the programming.

The computing apparatus is held by a testing structure that further holds and connects the automotive embedded device, the automotive component, and a plurality of tools. The tools are controlled by the computing apparatus and supplement the testing of the automotive embedded device.

A processor-based remote computing apparatus is disposed physically separate from the testing structure. The remote computing apparatus communicates with the computing apparatus through the network.

The execution of the programming includes the computing apparatus being controlled over the network by the remote computing apparatus (i) to cause the automotive embedded device to function and (ii) to perform the testing of the automotive embedded device. The execution of the programming further includes the computing apparatus being controlled over the network by the remote computing apparatus, in performing of the testing of the automotive embedded device, to cause the plurality of tools to provide (i) a plurality of varying physical conditions under which the automotive embedded device is tested and (ii) a plurality of mechanisms for observing and obtaining testing results.

A third embodiment disclosed herein describes a non-transitory computer-readable storage medium storing instructions. When the instructions are executed by a processor in a computing apparatus that tests an automotive embedded device, the computing apparatus perform steps similar to a result of the execution of programming in the computing apparatus of the second embodiment discussed above.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating a development/test environment, connected to a remote computer apparatus, which together form a system for remote testing of an automotive embedded device.

FIG. 2 is a block diagram providing a detailed view of a first embodiment of a system for testing an automotive embedded device.

FIG. 3 is a block diagram illustrating a testing structure used in a system for testing an automotive embedded device.

FIG. 4 is a block diagram illustrating a second embodiment of a system for testing an automotive embedded device, the system being at least partially disposed within a vehicle.

FIG. 5 is a block diagram illustrating a central computer used in a system for testing an automotive embedded device.

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented in a processor, are best supported with or in software or integrated circuits (ICs), such as a digital signal processor, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

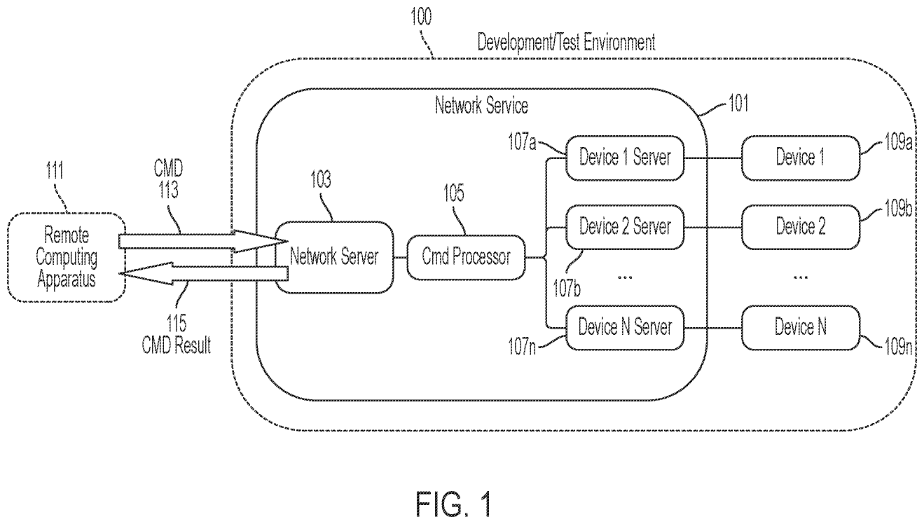

FIG. 1 is a block diagram illustrating a development/test environment 100 that is connected to a remote computing apparatus 111. The development/test environment 100 and the remote computing apparatus 111 together form a system for remote testing of an automotive embedded device (not shown). The development test environment 100 includes a network service 101, which represents the primary software engine in a central computer that processes remote commands from the remote computing apparatus 111.

The development/test environment 100 further includes devices 109a, 109b, . . . , 109n that represent physical devices that include (i) devices of the automotive component to be tested as well as (ii) devices that monitor and observe those devices to be tested. Stated another way, the devices 109a, 109b, . . . , 109n are devices connected to, and under the control of, the network service 101. Therefore, whatever device is to be tested, whether it be a windshield wiper, an infotainment system, an electronic brake, a headlamp, or any other, the device to be tested would be among devices 109a, 109b, . . . , 109n that are connected to the network service 101.

The remaining devices 109a, 109b, . . . , 109n that are not the device to be tested are necessarily the devices that observe and obtain testing results. As noted above, the devices observing and obtaining the testing results are connected to, and controlled by, the network service 101.

As indicated above, an automotive component that has a control device embedded therein may have multiple parts that need to be tested. An infotainment center is an example of such an automotive component. An infotainment center certainly includes a primary processing unit that includes an embedded control device. This primary processing unit would be among the devices 109a, 109b, . . . , 109n that are connected to, and controlled, by the network service 101.

Other parts of the infotainment center that need to be tested may include, for example, a display screen/touch screen, which both displays information to a user and accepts input from a user; a sound output device such as a speaker; and a camera configured to capture images of, for example, the driver of a vehicle. The infotainment center speaker and camera may be either built directly into the primary processing unit or may be standalone peripherals.

Testing of the automotive embedded device includes testing all the parts of the automotive component which the embedded device controls. In the development/test environment 100, most of the devices 109a, 109b, . . . 109n represent devices that observe and obtain testing results from the component parts being tested.

Turning back now to software engine that is the network service 101, a module acting as the network server 103 is connected to the remote computing apparatus 111. The network server 103 listens for testing commands 113 sent by the remote apparatus 111 over a communication network (not shown).

Once a command is received at the network server 103, the command processor 105 processes the command. This processing is generally a determination of which testing command is given, and which device 109a, 109b, . . . , 109n, will be carrying out testing instructions received in the command. Stated another way, command processing is primarily a determination of what testing will performed, and where testing instructions will be executed.

The testing commands are sent to devices 109a, 109b, . . . , 109n through an instruction layer containing device servers 107a, 107b, . . . , 107n. The device servers 107a, 107b, . . . , 107n are not physical computer servers, but rather are software modules that contain specific knowledge of how to communicate with, and command, corresponding devices 109a, 109b, . . . , 109n.

In this regard it should be noted that connectivity with the devices 109a, 109b, . . . , 109n creates unusual challenges in the testing system. Each of the devices 109a, 109b, . . . , 109n might be electrically connected in a different manner, including through a serial port connections, a parallel port connections, a USB connections, an HDMI connections, and other connections known in the art. Thus, the device server modules 107a, 107b, . . . , 107n are configured to communicate with corresponding devices 109a, 109b, . . . , 109n based on specific knowledge of the connectivity requirements of the devices 109a, 109b, . . . , 109n.

The command processor 105 evaluates the command 113 received, and determines which device server 107a, 107b, . . . , 107n executes the command based on what component part is being tested, and which devices 109a, 109b, . . . , 109n corresponds to the component part being tested. When received commands are appropriately routed, the device servers 107a, 107b, . . . , 107n proceed to prepare instructions (based on connectivity type and the type of testing being performed) for the devices 109a, 109b, . . . , 109n to perform testing tasks and/or events.

It should be noted that once the devices 109a, 109b, . . . , 109n are instructed to observe and obtain testing results, the testing results are passed back to the remote computing apparatus in the opposite direction. That is, network service 101 receives testing observation messages from the devices 109a, 109b, . . . , 109n through the corresponding device server modules 107a, 107b, . . . , 107n. The messages including testing results observed by devices 109a, 109b, . . . , 109n are interpreted by the command processor 105 and communicated by the network server 103 as a command result 115 to the remote computing apparatus 111.

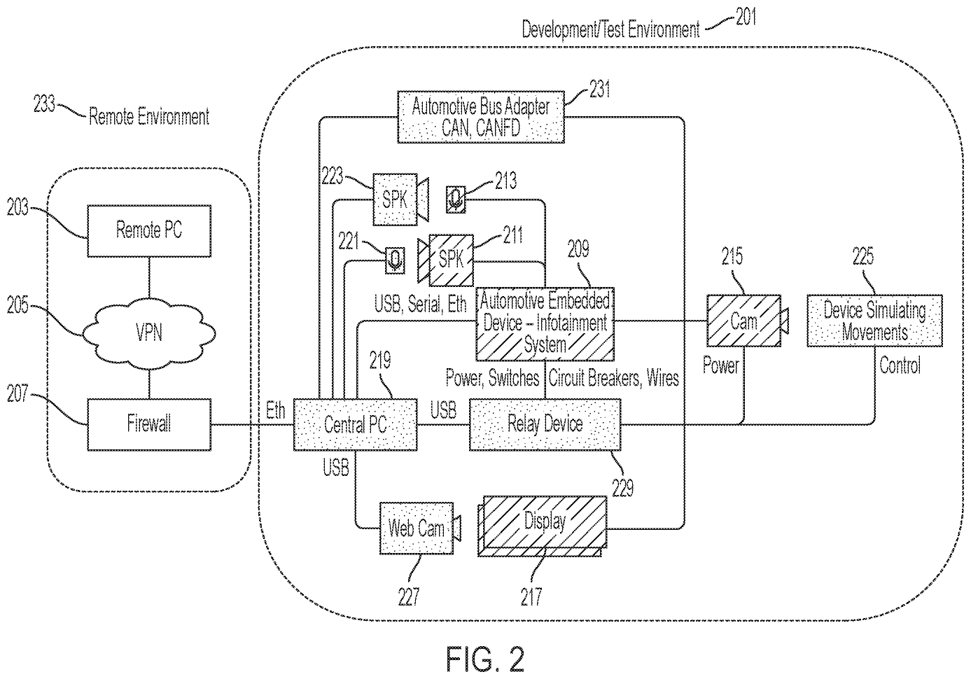

Turning now to FIG. 2, the drawing provides a detailed view of a first embodiment of a system for testing an automotive embedded device. The system for testing an automotive embedded device illustrated in FIG. 2 includes a development test/environment 201 and a remote environment 233.

The remote environment 233 includes a remote PC 203, a virtual private network (VPN), and a firewall 207. The remote PC 203 is a processor-based computing apparatus that drives and controls the testing of an automotive embedded device. It should be noted that in the embodiment of FIG. 1, the automotive embedded device is provided in an infotainment system 209, which is an automotive component. In the discussion below, the expression “infotainment system” and “embedded device” are used interchangeably.

The remote PC 203 in FIG. 2 is illustrated a single PC controlling testing of the embedded device 209. However, it should be understood that multiple remote users operating multiple computers can access the development/test environment 201 at substantially the same time.

The remote PC 203 communicates with the development/test environment 201 (and in particular, the central PC 219) via the VPN 205. The VPN 205 can be provided by the enterprise to which both the remote PC 203 and the central PC 219 belong, or it can be provided by a third-party provider.

As is known in the art, the firewall 207 monitors and controls incoming and outgoing network traffic between the remote PC 203 and the central PC 219 based on predetermined security rules. That is to say, the firewall 207 authenticates the remote PC 203 and the central PC 219 in communications and ensure propriety of messages.

The development/test environment 201 in FIG. 2 includes the central PC 219 and the automotive embedded device 209. The PC 219 is also a processor-based computing device that is referred to herein as a central device because, as noted above, multiple remote PCs 203 in various remote location may communicate with the central PC 219 at substantially the same time or different times.

The central PC 219 includes the network service software that was described above with reference to FIG. 1. Thus, the central PC 219 receives and interprets testing command messages from the remote PC 203, and prepares testing instructions to communicate to the infotainment system/embedded device 209. The communication line between the central PC 219 and the infotainment system/embedded device 209 may be any type of communication protocol including USB, serial port, ethernet, etc.

The infotainment system 209 has multiple parts, including a display(s) 217, a speaker 211, a microphone 213, and a camera 215. The display 217 is used for displaying information and graphics to a user, but also may be used for accepting input from the user. The speaker 211 is used for providing music or verbalization of text to the user. The microphone 213 accepts spoken input from the user.

The camera 215 is used to obtain observable input from a user of the infotainment system 209, such as a capturing movements or expressions of the user's face (leading to conclusions of an emotional state or a sleepiness state). The camera 215 may capture movements of the user such as movements of arms or hands.

The testing commands from the remote PC 203, forwarded to the embedded device in the infotainment system 209 through the central PC 219, may include varying inputs intended to provoke responses from the display 217, the speaker 211, the microphone 213, and the camera 215. In order to observe and obtain testing results of the embedded device, the development/test environment 201 further includes tools to observe and record the testing results. In the system for testing an automotive embedded device seen in FIG. 2, the tools for observing and obtaining testing results include the microphone 221, the speaker 223, the device simulating movements 225, the web cam 227, the relay device 229, and the communication protocols 231.

The testing commands from the remote PC 203, forwarded to the microphone 221 through the central PC 219, will cause the microphone 221 to record sound emanating from speaker 211 of the infotainment system 209 so as to determine whether the speaker 211 is functioning correctly. The testing commands from the remote PC 203, forwarded to the speaker 223 through the central PC 219, will cause the speaker 223 to produce sound so as to determine whether the microphone 213 of the infotainment system 209 is functioning correctly in recording sound. The testing commands from the remote PC 203, forwarded to the device simulating movements 225 through the central PC 219, will cause the device simulating movements 225 to operate and move so as to determine whether the camera 215 of the infotainment system 209 is functioning correctly in responding to the movements.

The testing commands from the remote PC 203, forwarded to the web cam 227 through the central PC 219, will cause the web cam 227 to operate to capture images from the display 217 of the infotainment system 209 to determine whether the display 217 is functioning correctly. The testing commands from the remote PC 203, forwarded to the relay device 229 through the central PC 219, will cause the relay device 229 to initiate powering on and off the infotainment system 209 via switches, fuses, wires, and circuit breakers. The powering on and off of the infotainment system 209 via the relay 209 will aid in determining whether the infotainment system 209 is functioning correctly. It should be noted that the relay 229 also provides power to the cam 215 and the device simulating movements 225.

The testing commands from the remote PC 203, forwarded to the communication protocols 231 through the central PC 219, will cause the communications protocols 231 to adjust communication connections to the infotainment system 209. The reactions by the infotainment system 209 to the change in communications protocols can be used to determine if the infotainment system 209 is working correctly.

It should be clear that the tools including the microphone 221, the speaker 223, the device simulating movements 225, the web cam 227, the relay device 229, and the communication protocols 231 supplement and complete the testing of the automotive embedded device in the infotainment system 209, which is the automotive component under scrutiny. The above-described tools 221, 223, 225, 227, 229, 231 are all disposed on a test bench that is may be referred to herein as testing structure.

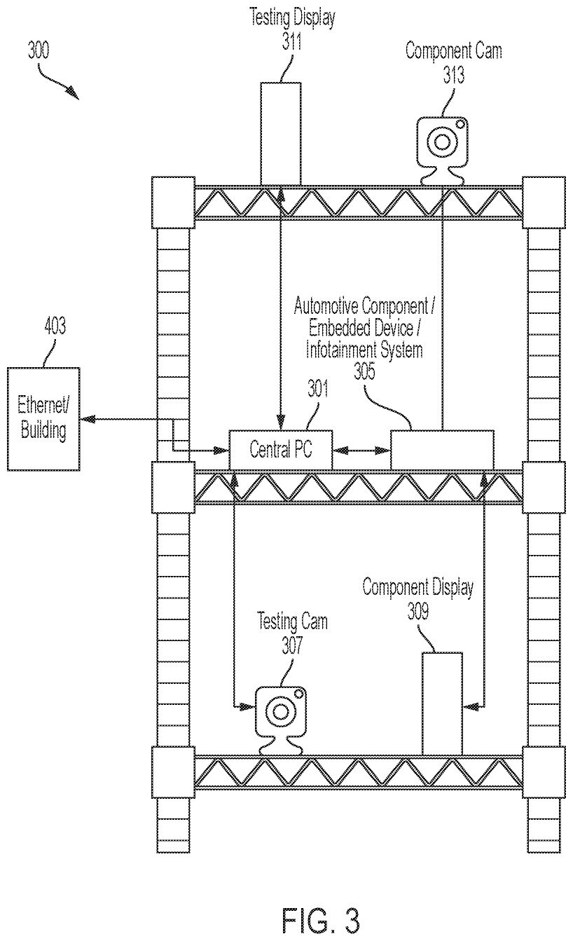

For ease of illustration, the testing structure is not seen in FIG. 2, but is demonstrated in FIG. 3. The testing structure/bench holds and connects the central PC 219, the infotainment center 209 as both an automotive component and embedded device, the constituents parts 211, 213, 215, 217 of the infotainment center 209, and the tools 221, 223, 225, 227, 229, 231 used for observing and obtaining testing results.

It should be clear that the remote PC 203 is disposed to be physically separate from the testing structure. As noted above, the remote PC 203 and the central PC 219 communicate over a network, seen in FIG. 2 as the VPN 205.

The remote PC 203 controls, over the VPN 205, the central PC 219 to undertake testing of the automotive embedded device 209. Based on commands from the remote PC 203, the central PC 219 initially causes and/or commands the infotainment center 209 to begin operation, i.e., to function. Based on commands from the remote PC 203, the central PC 219 further performs testing of the infotainment center 209 by providing one or more simulated events or inputs to determine whether the infotainment center 209 responds appropriately.

As noted above, the testing of the infotainment center could include using any of the tools 221, 223, 225, 227, 229, 231 to either (i) obtain test results or (ii) observe testing results of the main processing unit of the infotainment center 209 or the constituents parts 211, 213, 215, 217. More specifically, by tripping and resetting of a circuit breaker or by connecting and disconnecting of a wire providing current to the infotainment center 209, the relay board 229 obtains testing results of the infotainment center 209. Also, by changing communication connection types, the communication protocols 231 obtains testing results of the infotainment center 209.

The device simulating movements 225 further is used to obtain testing results of the cam 215 of the infotainment center 209. Also, the speaker 223 is used to obtain testing results of the microphone 213 of the infotainment center 209. In comparison, the web cam 227 observes the testing results of the display 217 of the infotainment center 209. In addition, the microphone 221 observes (and records) the testing results of the speaker 211 of the infotainment center 209. Succinctly put, when the remote PC 203 controls/commands the central PC 219 (i) to cause the tools 221 and 227 to observe testing results and (ii) to further cause the tools 223, 225, and 231 to obtain testing results, the remote PC 203 controls/commands the central PC 219 to cause the tools to provide a plurality of mechanisms that observe and obtain testing results

The remote PC 203 further controls, over the VPN 205, the central PC 219 to command and/or cause the relay 229 to power on and off the automotive embedded device 209. As such, the remote PC 203 is controlling/commanding the central PC 219 to cause the relay 229 to provide a plurality of physical condition under which the automotive embedded device 209 is tested.

Turning now to FIG. 3, a testing structure 300 that is used in a system for testing an automotive embedded device is shown. The testing structure 300 holds and connects a central PC 301, an automotive component (infotainment system) 305 having an embedded control device, an automotive component peripheral display 309, a testing (tool) cam 307, an automotive component peripheral cam 313, and a testing (tool) display 311.

It should be noted that the testing structure 300 is a simplified structure, some parts of the component infotainment system 305 that were described in FIG. 2 not being shown. Additionally, some testing tools used to obtain and observe testing result that were described in FIG. 2 are now shown. Additionally, specific connectors are not shown.

The testing structure 300 is an example of a central testing structure that would typically be disposed within a building, the testing being conducted in a simulated environment. The central PC 301 held on the testing structure 300 would be accessed by one or more remote PCs (not shown) that control and command testing of the automotive component 305 with the embedded control device.

The central PC 301 accesses commands from remote PCs through an ethernet connection 403 provided in the building in which the testing structure 300 is disposed. The ethernet 403 is connected with one or more networks (not shown) to facilitate connections with the one or more remote PCs.

Based on commands from a remote PC, the central PC 301 causes and/or commands the infotainment center 305 to begin operation, i.e., to function. Once the infotainment center 305 is functioning, testing commands received from the remote PC may be forwarded to the testing cam 307 through the central PC 301. These commands cause the testing cam 307 to operate to capture images from the component display 309 to determine whether the component display 309 and the infotainment center 305 are functioning correctly.

The component cam 313 is used to obtain input from a user of the automotive component/infotainment system 305. The component cam 313 may capture expressions of the user's face or capture movements of the user. In the simulated environment of FIG. 3, the component cam 313 may capture still images of user expressions or may capture live video images of a user provided on testing display 311. The testing display 311 on which the images of expressions are provided, is connected to the central PC 301.

In FIG. 3, testing commands from a remote PC, forwarded to the testing display 311 through the central PC 301, will cause the display 311 to operate so as to provide images of expressions of a user. This helps determine whether the component camera 313 and the infotainment system 305 are functioning correctly.

As noted above, FIG. 3 illustrates a testing structure 300 that is disposed in a building, and the testing performed may be considered simulated in that the operation of the embedded device 305 occurs outside of a vehicle. However, it should be noted that a testing structure with a central PC and a plurality of testing tools may be provided in a vehicle (automobile) where testing is performed on an embedded device and an automotive component that are installed in the vehicle. When the testing structure is provided in a vehicle, the structure will necessarily have a (substantially) different mechanical appearance, but the functionality of the testing structure of connecting the central PC, the automotive embedded device, the automotive component, and the plurality of tools remains the same.

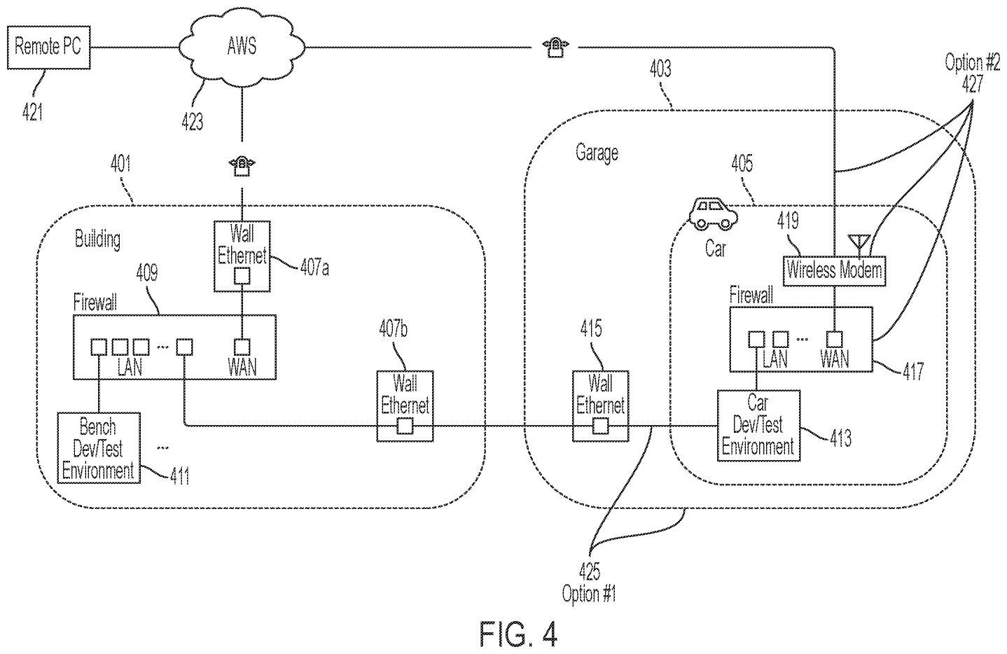

FIG. 4 is a block diagram illustrating a second embodiment of a system for testing an automotive embedded device where the testing structure may be disposed in a vehicle. In FIG. 4, the testing of the automotive embedded device may be performed in an actual driving environment.

In FIG. 4, a building 401 and car 405 each have a development/test environment 411, 413 for performing testing of an automotive embedded device, each development/test environment 411, 413 being provided in a central PC (not shown) that is further provided on a testing structure (not shown). The respective testing structure in the building 401 and the car 405 holds and connects a respective development/test environment 411, 413 in a respective PC with a respective embedded device and respective tools for conducting testing the respective embedded device.

FIG. 4 further shows that there are two options 425, 427 for testing of the embedded device in the car 405. The first option 425 for testing the embedded device in the car 405 is performed when the car 405 is stationary within a garage 403. The second option 427 for testing the embedded device in the car 405 is performed when the car 405 is being driven outside the garage 403. The first option 425 is a wired option, and the second option 427 is a wireless option.

In FIG. 4, a remote PC 421 is connected through a proprietary cloud network 423 such as Amazon Web Service (AWS) to provide control and testing commands to the bench development/test environment 411 (and a corresponding central PC) in the building 401. The building 401 includes at least two wall ethernet connectors 407a, 407b to pass testing commands received from the remote PC 421. The testing commands from the remote PC 421 are received at the wall ethernet connector 407a and forwarded to firewall 409.

When the security of commands received from the remote PC 421 are confirmed by the firewall 409, the testing commands will then be performed on a test bench in the building 401, using the bench development/test environment 411, and/or on a test structure in the car 405 using the car development/test environment 413 while the car 405 is stationary in the garage 403. Which test bench/structure (building or car) will perform the testing will be determined according to instructions in the commands provided by the remote PC 421.

If testing is to be performed according to the first wired option 425 on the test structure in the car 405, using the development/test environment 413, when the car 405 is stationary in the garage 403, the commands are passed through the second wall ethernet connector 407b of the building 401 to the wall ethernet connector 415 of the garage 403. The commands are then further passed to the car development/test environment 413.

If testing is to be performed according to the second wireless option 427 on the test bench in the car 405, using the development/test environment 413, when the car 405 is being driven outside of the garage 403, commands are provided from the remote PC 421 through the cloud 423 to the wireless modem 419 that is disposed in the car 405. The modem 419 is configured to receives communications using wireless networks such as 5G, 4G, and LTE.

Commands received through the modem 419 from the remote PC 421 must first be authenticated and security determined at the firewall 417 provided in the car 405. When the security of commands received from the remote PC 421 are confirmed by the firewall 417, testing is then performed in the car development/test environment 413 while the car 405 is mobile outside of the garage 403. Testing of the automotive embedded device in the car 405 is thus performed where parts of the automotive component under scrutiny are performing under actual driving conditions.

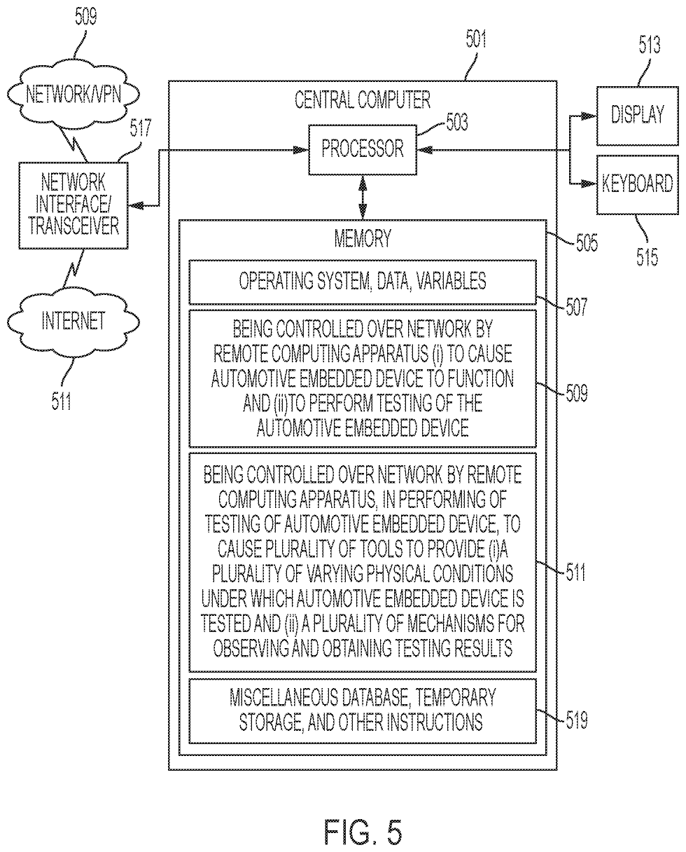

FIG. 5 is a block diagram illustrating a central computer 501 used in a system for testing an automotive embedded device. The central computer 501 may include a transceiver 517, a processor 503, a memory 505, a display mechanism 513, and a keypad and/or touch screen 515. The central computer 501 further includes a bus (not shown) configured to transfer data among the memory 505, the transceiver 517, and the processor 503.

The transceiver 517 may be equipped with a network interface that allows the central computer 501 to communicate with other devices on private and/or proprietary networks 509. The network interface further allows the central computer 501 to communicate with other devices on public networks such as the Internet 511.

The processor 503 may comprise one or more microprocessors and/or one or more digital signal processors. The memory 505 may be coupled to the processor 503 and may comprise a read-only memory (ROM), a random-access memory (RAM), a programmable ROM (PROM), and/or an electrically erasable read-only memory (EEPROM).

The memory 505 may include multiple memory locations for storing, among other things, an operating system, data and variables 507 for computer programs executed by the processor 503. The computer programs cause the processor 203 to operate in connection with various functions as now described.

A cause-testing-to-occur function 509 results in the processor 503 causing the central PC 501 to be controlled over a network by a remote computing apparatus (i) to cause an automotive embedded device to function and (ii) to perform testing of the automotive embedded device. A providing-testing-events function 511 results in the processor 503 causing the central PC 501 to be controlled over the network by the remote computing apparatus, in performing of the testing of the automotive embedded device, to cause a plurality of tools to provide (i) a plurality of varying physical conditions under which the automotive embedded device is tested and (ii) a plurality of mechanisms for observing and obtaining testing results.

The above described functions stored as computer programs may be stored, for example, in ROM or PROM and may direct the processor 503 in controlling the operation of the central computer 501 used in a system for testing an automotive embedded device. The memory 505 can additionally store a miscellaneous database and temporary storage 519 for storing other data and instructions not specifically mentioned herein.

A more precise technical description of the computer devices, networks, and connections illustrated FIG. 2 (and corresponding counterparts illustrated in FIGS. 1 and 3-5, which are not specifically mentioned by reference character below) is now provided. It should be noted that conflicts in descriptions of components should be viewed as alternative arrangements or configurations.

Each of the remote PC 203 and central PC 219 (collectively referred to herein as “computer systems/networks 203, 219” or referred to in the singular as “computer system/network 203, 219”) may be viewed as a computer system or network. The computer systems/networks 203, 219 may communicate with each other over any network such as the Internet, an intranet, or any public or private network. Each computer system/network 203, 219 may be programmed to operate in automated fashion, and may also have an analog or a graphical user interface such as Outlook and Windows such that users can control computer systems/network 203, 219. Each computer system/network 203, 219 may be programmed to operate through a command-line interface and/or may be controlled through a command-line interface.

Each computer system/network 203, 219 may include at least a central processing unit (CPU) with data storage such as disk drives, the number and type of which are variable. In each computer system/network 203, 219 there might be one or more of the following: a floppy disk drive, a hard disk drive, a solid state drive, a CD ROM or digital video disk, or other form of digital recording device.

Each computer system/network 203, 219 may include one or more displays upon which information may be displayed. Input peripherals, such as a keyboard and/or a pointing device, such as a mouse, may be provided in each computer system/network 203, 219 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system/network 203, 219 may interconnect peripherals previously mentioned herein through a bus supported by a bus structure and protocol. The bus may serve as the main source of communication between components of each computer system/network 203, 219. The bus in each computer system/network 203, 219 may be connected via an interface.

The CPU of each computer system/network 203, 219 may perform the calculations and logic operations required to execute the functionality of each computer system as described in this disclosure. The functionality of each computer system/network 203, 219 may be processed in an automated fashion such that relevant data is processed without user administrator assistance or intervention. Alternatively, or additionally, the functionality of each computer system/network 203, 219 may be processed in a semi-automatic fashion with intervention from a user administrator at one or more of the computer systems/networks 203, 219. Alternatively, or additionally, the functionality of computer system/network 203, 219 may be improved based on learning, problem-solving, or rational choice-making obtained through current or future artificial intelligence techniques. Implementing, processing, and executing the functionality of each computer system/network 203, 219 as described in this disclosure is within the purview and scope of one of ordinary skill in the art, and is not discussed in detail herein.

Each computer system/network 203, 219 may be implemented as a distributed computer system or a single computer. Similarly, each computer system/network 203, 219 may be a general purpose computer, or a specially programmed special purpose computer. Moreover, processing in each computer system/network 203, 219 may be controlled by a software program on one or more computer systems or processors, or could even be partially or wholly implemented in hardware. The computer systems/networks 203, 219 used in connection with the functionality may rely on the integration of various components including, as appropriate and/or if desired, hardware and software servers, database engines, and/or other content providers.

Although the computer systems/networks 203, 219 in FIG. 2 are illustrated as being a single device or computer, each computer system according to one or more embodiments of the invention is optionally suitably equipped with a multitude or combination of processors or storage devices. For example, each computer illustrated in computer systems and network 203, 219 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system/network 203, 219 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems/networks 203, 219. For example, at least some of the functionality mentioned above could be implemented using Visual Basic, C, C++, or any assembly language appropriate in view of the processor being used. It could also be written in an interpretive environment such as Java and transported to multiple destinations to various users.

It is likely that one or more of the computer systems/networks 203, 219 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system/network 203, 219 may be connected over the Internet, an intranet, or over a further network. Links to any network may be a dedicated link, a modem over a POTS line, and/or any other method of communicating between computers and/or users.

Each computer system/network 203, 219 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database is optionally distributed and/or networked.

This disclosure is intended to explain how to fashion and use various embodiments in accordance with inventive principles, rather than to limit the true, intended, and fair scope and spirit thereof. The foregoing description is not intended to be exhaustive or to limit the inventive principles to the precise form disclosed. Modifications or variations are possible in light of the above teachings. The embodiments disclosed and discussed herein were chosen and described to provide the best illustration of the inventive principles and the practical application thereof, and to enable one of ordinary skill in the art to utilize the inventive principles in various embodiments and with various modifications as are suited to the particular use contemplated. All such modifications and variations should be deemed to be within the scope of the inventive principles disclosed herein.

What is claimed is:

1. A system of testing an automotive embedded device, the automotive embedded device being hardware embedded in an automotive component, the system comprising:
a processor-based central computing device;
a plurality of tools, controlled by the central computing device, that supplement the testing of the automotive embedded device;
a testing structure that holds and connects the central computing device, the automotive embedded device, the automotive component, and the plurality of tools; and
a processor-based remote computing device that is disposed physically separate from the testing structure, the remote computing device and the central computing device communicating through a network, wherein
the remote computing device controls, over the network, the central computing device (i) to cause the automotive embedded device to function and (ii) to perform the testing of the automotive embedded device, and
the remote computing device further controls, over the network, in performing the testing of the automotive embedded device, the central computing device to cause the plurality of tools to provide (i) a plurality of varying physical conditions under which the automotive embedded device is tested and (ii) a plurality of mechanisms that observe and obtain testing results.

2. The system of testing according to claim 1, wherein
the testing structure is provided in a building, and
the automotive embedded device is tested while the automotive component operates in a simulated driving environment.

3. The system of testing according to claim 1, wherein
the testing structure is provided in a vehicle, and
the automotive embedded device is tested while the automotive component operates in an actual driving environment.

4. The system of testing according to claim 1, wherein
the remote computing device and the central computing device communicating through the network includes communicating through a proprietary cloud.

5. The system of testing according to claim 1, wherein
the plurality of tools includes a relay board that that is connected to the central computing device and to the automotive embedded device, and
the varying physical conditions under which the automotive embedded device is tested include starting and stopping of power to the automotive embedded device via the relay board.

6. The system of testing according to claim 1, wherein
the varying physical conditions under which the automotive embedded device is tested include (i) tripping and resetting of a circuit breaker that controls power to the automotive component and (ii) connecting and disconnecting of a wire to the automotive component.

7. The system of testing according to claim 6, wherein
the plurality of mechanisms for observing and obtaining test results include:
a web camera,
a speaker,
a microphone,
an automotive bus adapter,
a device simulating movements, and
testing software.

8. A computing apparatus for testing an automotive embedded device, the automotive embedded device being hardware embedded in an automotive component, the computing apparatus comprising:
a transceiver configured to transmit and receive data over a network;
a processor;
an electronic data storage storing programming; and
a bus configured to transfer data among the electronic data storage, the transceiver, and the processor, rendering the processor cooperatively operable with the electronic data storage and the transceiver to execute the programming, wherein
the computing apparatus is held by a testing structure that further holds and connects the automotive embedded device, the automotive component, and a plurality of tools that are controlled by the computing apparatus and that supplement the testing of the automotive embedded device,
a processor-based remote computing apparatus that is disposed physically separate from the testing structure communicates with the computing apparatus through the network,
the execution of the programming includes the computing apparatus being controlled over the network by the remote computing apparatus (i) to cause the automotive embedded device to function and (ii) to perform the testing of the automotive embedded device, and
the execution of the programming further includes the computing apparatus being controlled over the network by the remote computing apparatus, in performing of the testing of the automotive embedded device, to cause the plurality of tools to provide (i) a plurality of varying physical conditions under which the automotive embedded device is tested and (ii) a plurality of mechanisms for observing and obtaining testing results.

9. The computing apparatus according to claim 8, wherein
the testing structure is provided in a building, and
the automotive embedded device is tested while the automotive component operates in a simulated driving environment.

10. The computing apparatus according to claim 8, wherein
the testing structure is provided in a vehicle, and
the automotive embedded device is tested while the automotive component operates in an actual driving environment.

11. The computing apparatus according to claim 8, wherein
the remote computing apparatus communicates with the computing apparatus through the network using a proprietary cloud.

12. The computing apparatus according to claim 8, wherein
the plurality of tools includes a relay board that that is connected to the computing apparatus and to the automotive embedded device, and
the varying physical conditions under which the automotive embedded device is tested include starting and stopping of power to the automotive embedded device via the relay board.

13. The computing apparatus according to claim 8, wherein
the varying physical conditions under which the automotive embedded device is tested include (i) tripping and resetting of a circuit breaker that controls power to the automotive component and (ii) connecting and disconnecting of a wire to the automotive component.

14. The computing apparatus according to claim 13, wherein
the plurality of mechanisms for observing and obtaining test results include:
a web camera,
a speaker,
a microphone,
an automotive bus adapter,
a device simulating movements, and
testing software.

15. A non-transitory computer-readable storage medium having instructions stored thereon, that when executed by a processor in a computing apparatus that tests an automotive embedded device, causes the computing apparatus to perform steps, wherein
the automotive embedded device is hardware embedded in an automotive component,
the computing apparatus is held by a testing structure that further holds and connects the automotive embedded device, the automotive component, and a plurality of tools that are controlled by the computing apparatus and that supplement the testing of the automotive embedded device,
a processor-based remote computing apparatus that is disposed physically separate from the testing structure communicates with the computing apparatus through a network, and
the steps performed by the computing apparatus comprise:
based on control by the remote computing apparatus over the network: (i) causing the automotive embedded device to function and (ii) performing the testing of the automotive embedded device; and
based on control by the remote computing apparatus over the network, in performing the testing of the automotive embedded device, causing the plurality of tools to provide (i) a plurality of varying physical conditions under which the automotive embedded device is tested and (ii) a plurality of mechanisms for observing and obtaining testing results.

16. The non-transitory computer-readable storage medium according to claim 15, wherein
the testing structure is provided in a building, and
the automotive embedded device is tested while the automotive component operates in a simulated driving environment.

17. The non-transitory computer-readable storage medium according to claim 15, wherein
the testing structure is provided in a vehicle, and
the automotive embedded device is tested while the automotive component operates in an actual driving environment.

18. The non-transitory computer-readable storage medium according to claim 15, wherein
the plurality of tools includes a relay board that that is connected to the computing apparatus and to the automotive embedded device, and
the varying physical conditions under which the automotive embedded device is tested include starting and stopping of power to the automotive embedded device via the relay board.

19. The non-transitory computer-readable storage medium according to claim 15, wherein
the varying physical conditions under which the automotive embedded device is tested include (i) tripping and resetting of a circuit breaker that controls power to the automotive component and (ii) connecting and disconnecting of a wire to the automotive component.

20. The non-transitory computer-readable storage medium according to claim 19, wherein
the plurality of mechanisms for observing and obtaining test results include:
a web camera,
a speaker,
a microphone,
an automotive bus adapter,
a device simulating movements, and
testing software.
